(19) United States
(12) Patent Application Publication
(10) Pub. No.: US 2022/0246056 A1
(43) Pub. Date: Aug. 4, 2022

(54) SYSTEM AND METHOD FOR IMPROVING VERBAL SKILLS

(71) Applicant: KODA-TEC LLC, Long Beach, NY (US)

(72) Inventor: Robert E. KODADEK, III, Long Beach, NY (US)

(21) Appl. No.: 17/590,149

(22) Filed: Feb. 1, 2022

Related U.S. Application Data
(60) Provisional application No. 63/144,105, filed on Feb. 1, 2021.

(51) Int. Cl. G09B 19/00; G09B 5/02

(52) U.S. Cl. CPC G09B 19/00; G09B 5/02

(57) ABSTRACT

A system and method for improving verbal skills—i.e., both written and spoken language skills—may include one or more hardware devices, including a processor or processors configured to execute an instruction set embodying an embodiment of the method. The system may also include read-only memory (ROM), random-access memory (RAM), or both. At least some embodiments may include a software tool run on a hardware device such as described above. The software tool may be configured to check spelling, grammar, or both, and then identify incorrect words or phrases, but not provide a correction until the user has attempted to make the correction themselves.

### CROSS REFERENCE TO RELATED APPLICATIONS

This application claims the benefit of U.S. provisional application Ser. No. 63/144,105 filed Feb. 1, 2021, the disclosure of which is hereby incorporated in its entirety by reference herein.

### TECHNICAL FIELD

The present disclosure relates to a system and method for improving verbal skills.

### BACKGROUND

As more and more students move away from hand writing notes and assignments, and increase their use of online and other computer-based learning, including various writing and presentation platforms, they can take advantage of applications and software tools designed to correct spelling and grammar. These tools are typically preinstalled in the software programs—including being built into web-browsers—they are present at all times and provide corrections automatically.

The advantage of these tools is that they provide efficiency and ease in writing. When a word is spelled incorrectly or if the grammar is flawed, the mistake will be identified by the software tool, which may provide the user with a correction, or in some cases, the tool automatically replaces the text with the correction without any input from the user. The obvious disadvantage is that this can hinder children from learning to write and spell correctly on their own.

By way of example, if a student types “the cta sat on the matt”, some spelling and grammar tools would identify and provide the correct spelling of “cat” and “mat” along with an identifier—underline, highlight, etc.—that shows that “The” should have a capital “T”. Because these tools will automatically correct the grammar and spelling without the student needing to think about the correction, students can miss the opportunity to learn these critical skills.

Further, existing spell and grammar check tools provide instantaneous review of text and do not track users' historical accuracy or ability. Due to this fact, these tools cannot provide a means to identify words or grammar rules which were incorrectly spelled or utilized or are challenging for specific users. Thus, they do not offer a means for improvement.

Therefore, a need exists for a system and method for improving verbal skills that can help identify misspelled words and incorrect grammar, but not automatically provide the corrections, which could help students learn spelling and grammar more quickly and more accurately. Additionally, a system which could track the history of “proofreading correctness” (i.e. errors and text using correct spelling and grammar), would provide a means for customized, targeted learning activities and additional means of improvement specifically tailored for each student.

### SUMMARY

At least some embodiments described herein may include a system and method for improving verbal skills—i.e., both written and spoken language skills. The system may include one or more hardware devices, including a processor or processors configured to execute an instruction set embodying an embodiment of the method.

At least some embodiments described herein may include a software tool run on a hardware device such as described above. The software tool may be configured to check spelling, grammar, or both, and which identifies incorrect words or phrases, but does not immediately provide the correction. Instead of providing the correction, the tool may challenge the user to make the correction themselves through a variety of methods including proofreading games based on errors identified in the document. The tool may be a stand-alone software program—e.g., a program that resides on a desktop or laptop computer—it may be implemented on a browser extension, it may be configured as an application on a mobile device, as a cloud based application or it may be configured as an add-on tool to support an existing word processor, browser, or presentation software—e.g., Google Docs, MS PowerPoint, etc.

Embodiments described herein may operate in several ways, for example, in the case of spelling errors (Note: similar rules could apply for grammatical errors) some or all of the following steps may be performed:
Identify the misspelled word by highlighting, underlining, or any other form of cue to the user.
The software may be run on a continuous basis, to identify misspelled words as they are typed, or at any time during the course of a user's work. For example, misspelled words may be hidden or not be identified while a user is working (potentially to reduce distraction), and presented after a sentence, a paragraph or a whole document has been written.
Words used in the text may be saved in a database to build a custom repository reflecting “proofreading correctness”; used herein to mean the accuracy of the analyzed text or the words that the student has spelled correctly or incorrectly. This data may provide a means for custom analysis of one or more students' progress, words they are struggling with and words which have been mastered.
When the identified word has been identified, is selected or “moused over”, the system may provide one or more of the following:
   The system may provide the opportunity for the student to correctly spell the word—for example, in a pop-up window or in-situ (in the existing text).
   A variety of correction input methods may be used, including games.
   As one example, the student may then attempt to provide the correct answer by selecting a word from a multiple-choice list of different spellings.
   As another example, the system may provide the student a letter jumble or word game containing the correct letters or groups of letters from the incorrectly spelled word to help them spell the word correctly.
   Alternately, or in addition to the letter jumble, the student may be provided a problem related to their school subjects—e.g., math, science, etc., to solve in exchange for the answer.
The type of help the system provides may be adjusted for the age and grade of the student and the particular goals and needs of the student.
A reward system may be implemented which provides additional incentives to the user, for example points may be awarded to the student based on different outcomes or events. For example, the system may implement one or more of the following:
   An overall accuracy rate may be determined for the document itself, enabling a reward of points relative to the document as a whole.
   A database may be used to store information with respect to which words the user has previously spelled correctly or incorrectly. Words that are spelled correctly, but which the student has a history of spelling incorrectly, may be awarded points.
   Words that are spelled incorrectly, but which the student can successfully correct, may be awarded points.
   If a word is spelled correctly, points may be awarded as a bonus to augment an overall tally. For instance, words spelled correctly the first time, which were previously misspelled, or which reflect a relatively high degree of difficulty may provide a reward.
   If a word is spelled incorrectly, points may be deducted from the overall tally.
   Words identified by the student or an administrator (e.g., parent or teacher) may augment the points tally.
A scoreboard may be provided to the user to show an historical score along with a current-document score.

A student's overall performance through a period of time may be tallied through the points awarded as described above, allowing tallies to be tracked individually or collectively. For example, a student's point tally may be compared with the point tallies of others—e.g., other members of the same class. Alternatively, the points may be tallied at a class level—e.g., allowing all classmates to work toward a collaborative goal, or in larger groups to promote fun and competition or to consolidate and compare scores on a scoreboard. Rewards may be provided individually or at the group level—e.g., a student may be allowed to pick a prize from a box, or a class as a group may have a party if the total score exceeds a certain threshold.

The system and subsequent point tally may be used to provide external rewards offered by teachers, parents, or by third-party partners—e.g. discounts at ice cream store, free items from online video games, etc. A marketplace may be utilized to present reward options to users and to provide incentives for higher-level scores; in some embodiments, points may be saved to increase the total to allow students to get more desirable rewards. Parents or teachers may set up custom rewards, keep track of points via a mobile-software application that is compatible with the system, receive reports on correct and incorrect words, identify a reading level of the student, provide suggestions for teaching or coursework, or suggest products from third parties to support student.

At least some embodiments would include a timer that would track the time it takes for a student to correctly spell the previously incorrectly spelled word. The timer may limit the time a student has to correctly spell the word or correct the grammar. The timer function may also be used to ensure that the students could not get around the software by using an alternate means to find the correct spelling or grammar—e.g., by using an electronic dictionary, opening a new browser, or using other software outside of the system.

Although the examples described above illustrate how embodiments may improve a student's written-language skills, it is understood that when a student's written grammar improves, it may readily transfer from writing to reading to speaking. In this way, a student's overall verbal skills—written and spoken—may benefit from such a system or method.

Because embodiments of systems and methods described herein may include a software tool executed on electronic hardware, such as a computer, they provide advantages over learning techniques that may be implemented manually. For example, data with respect to proofreading errors made by users may be collected, aggregated, and stored in an electronic database—see description below in conjunction with the drawing figures. This data may be utilized to analyze different teaching methods by different types of teachers and learners to help them optimize how students are taught and to customize learning activities to the specific student's need. This type of analysis would not be possible with a manually implemented system or using traditional proofreading methodologies or tools (i.e., grammar check or spell checkers)—i.e., it is only possible with a computer-based system and method as described herein.

Use of a computer-based system and method may enable the use of data analytics, artificial intelligence, and/or machine learning applications, which can be used to learn and suggest—and potentially create—learning modules specialized for each student. The system and method may also provide important insights to parents on customized support systems for their children and provide recommendations for reading, custom word games and puzzles based on their specific needs and alternative products to help them learn. The data generated may be used to identify students who should receive more help and those who are advanced—this, in turn, may facilitate students potentially advancing (skipping) grades, thereby reducing education costs, and identifying and making room for those who need more help.

Another feature of embodiments described herein is that it allows implementation of a learning system on a scale not achievable in a manual system. A computer-based system and method as described herein not only enables a learning system to be performed at the student and class level, but it may be implemented to enable whole demographics of students' abilities to be assessed and compared to enable support and improvement across the entire set of students. This could be performed at the class, state, country, or local level—a Herculean task not achievable with a manual system.

### BRIEF DESCRIPTION OF THE DRAWINGS

FIG. 1 is a system diagram of a system for improving verbal skills, in accordance with an embodiment described herein;

FIG. 2 is a flowchart illustrating a method in accordance with an embodiment described herein;

FIG. 3 is an example of a document including a spelling error;

FIG. 4 is an example of the document of FIG. 3 showing a pop-up correction window;

FIG. 5 is an example of the document of FIGS. 3-4 into which the user has entered a replacement for the spelling error;

FIG. 6 is an alternate example of the pop-up correction window providing a word jumble puzzle;

FIG. 7 is an example of a sidebar integration of the software tool into the user interface for editing the document;

FIG. 8 is an example of a game interface provided by the software tool integrated into the user interface for editing the document;

FIG. 9 is an alternate example of a game interface provided by the software tool integrated into the user interface for editing the document;

FIG. 10 is an example reporting interface for a student user of the system;

FIG. 11 is an example reporting interface for a student user of the system showing a details view for a word;

FIG. 12 is an example reporting interface for a student user of the system showing a mastered words listing;

FIG. 13 is an example reporting interface for a student user of the system showing a challenge words listing;

FIG. 14 is an example reporting interface for a student user of the system showing a team score view;

FIG. 15 is an example reporting interface for a teacher user of the system showing a classroom view; and

FIG. 16 is an example of a computing device for use in improving verbal skills.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

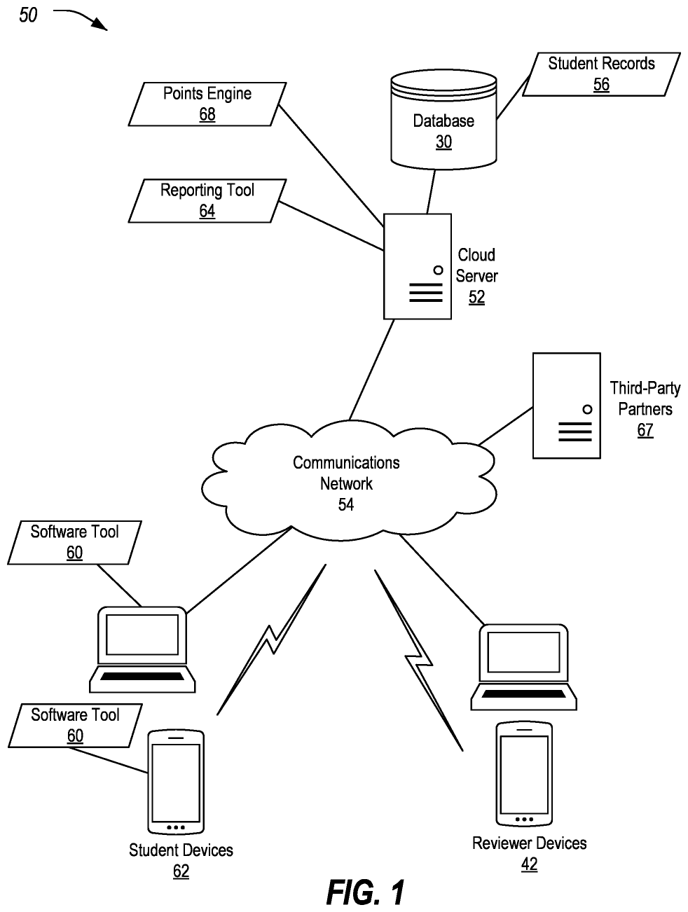

FIG. 1 illustrates aspects of a system 50 for improving verbal skills. As illustrated, the system 50 includes a cloud server 52 hosting a database 30 configured to store student records 56 defining the users of the system 50 as well as their progress. The cloud server 52 may be configured to communicate with student devices 62 and reviewer devices 42 over a communication network 54. Using a software tool 60 installed thereon or otherwise accessible to the student devices 62, the cloud server 52 may be configured to facilitate the gamification for improving verbal skills. Instead of simply indicating proofreading errors to the student, the software tools 60 may instead identify those mistakes and offer gameplay to the student in various manners to allow the student to learn the correction to the proofreading error. The cloud server 52 may also host a points engine 58 to analyze performance of the students and a reporting tool 64 to provide management functionality to the reviewer devices 42. The reporting tool 64 may be, for example, a web-based dashboard accessible via the student devices 62 and/or reviewer devices 42.

The database 30 may include various types of computing apparatus, such as a computer workstation, a server, a virtual server instance executed by a mainframe server, or some other computing system and/or device. Computing devices, such as the cloud server 52, generally include a memory on which computer-executable instructions may be maintained, where the instructions may be executable by one or more processors of the computing device. Such instructions and other data may be stored using a variety of computer-readable media. A computer-readable medium (also referred to as a processor-readable medium or storage) includes any non-transitory (e.g., tangible) medium that participates in providing data (e.g., instructions) that may be read by a computer (e.g., by the processor of the cloud server 52). In general, a processor receives instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, structured query language (SQL), etc.

The communication network 54 may include one or more interconnected communication networks such as the Internet, a cable television distribution network, a satellite link network, a local area network, a wide area networks, and a telephone network, as some non-limiting examples.

The student devices 62 and reviewer devices 42 may include various devices configured to communicate with the cloud servers 52 over the communication network 54. These student devices 62 and reviewer devices 42 may include laptop computers, tablets or other handheld computers, mobile phones, smartwatches, computer workstations, servers, desktop computers, or various other computing systems and/or devices configured to receive textual input for correction.

The software tool 60 may be computer software configured to check spelling, grammar, or both. The software tool 60 may identify incorrect words or phrases, but in many examples may not immediately provide the correction. For instance, the software tool 60 may identify the misspelled word by highlighting, underlining, or any other form of cue to the user. In some examples, the proofreading errors may be identified as a background operation while the user is working. In this example, the error may not be presented to the user as to not hinder workflow or concentration. In other examples, the proofreading errors may be identified responsive to initiation of a view of the software tool 60 in which the text is being reviewed interactively with the user. When the identified word is selected or “moused over”, or when the software tool 60 is initiated, the software tool 60 may provide an opportunity for the student to correctly spell the word—for example, in a pop-up window or in-situ (in or above the existing text).

Using the software tools 60, the student may attempt to provide a correct answer in various gameified ways. As used herein, the term “proofreading game” refers to a game or other task offered to a user, where instead of simply displaying a correction of the proofreading error, the game is designed to provide an opportunity to try again, which in some embodiments include guiding the user into providing the correction of the proofreading error. For instance, the software tool 60 may display a proofreading game interface to allow the student to select a word from a multiple-choice list of different spellings. Or the software tool 60 may display a proofreading game as a letter jumble, configured with at least some of the letters needed to spell the word, which assists the student in their attempt to spell the word correctly. Or, the software tool 60 may provide a proofreading game that asks the user to try again to spell the word. Or the software may provide portions of a sentence (in the case of incorrect grammar) or a misspelled word (in the case of misspelling) which can be reconfigured by the user into the correct order. Alternately, or in addition to the gamified input options, the student may be provided a problem related to their school subjects—e.g., math, science, etc., to solve in exchange for the answer.

The software tool 60 may implement a timer to track the time it takes for a student to correctly spell a previously incorrectly spelled word. The timer may limit the time a student has to correctly spell the word or correct the grammar. The timer function may also be used to ensure that the students may not get around the software by using an alternate means to find the correct spelling or grammar—e.g., by using an electronic dictionary, opening a new browser, or using other software outside of the system.

The software tool 60 may be a stand-alone software program—e.g., a program that resides on the storage of the student devices 62. In another example, the software tool 60 may be implemented on a browser extension. In yet another example, the software tool 60 may be configured as an application on the student devices 62. In still another example, the software tool 60 may be configured as an add-on tool to support an existing word processor, browser, or presentation software—e.g., Google Docs, Microsoft Word, Microsoft PowerPoint, etc.

The database 30 may be configured to store the student records 56. The student records 56 may include account information with respect to users set up to operate the software tool 60. This account information may include identifying information for the student, such as username, email address, and/or a picture of the student, classmates of the student, teachers to which the student is assigned, teammates that the student works together with to improve verbal skills, a student's grade and school, etc. The account information may also include statistics with respect to usage of the software tool 60. These statistics may include information indicative of which words have historically been spelled correctly or incorrectly by the student, points or rewards that are earned by the student, levels of achievement earned by the student, awards or badges earned by the student, permission settings, words selected by the teacher which are part of the student's then current curriculum, etc.

Responsive to the software tool 60 identifying one or more words that are spelled correctly or incorrectly by the user, the software tool 60 may send those words to the cloud server 52 to update a tally of how many times the word is spelled correctly by the user, and how many times the word is spelled incorrectly by the student. This information, as well as other information described herein, may be maintained in the student records 56 for the student.

The reviewer devices 42 may utilize the software tool 60, in various embodiments as mentioned with respect to the student devices 62 to provide access to the cloud server 52. As another possibility, the reviewer devices 42 may be configured to access the cloud server 52 by using a web browser or mobile application. The reviewer devices 42 may generally be used to allow a reviewer to see results for a single student or for more than one student (e.g., a teacher may see results from all the students in a class, grade, team etc.). In the case of multiple students, the reviewer devices 42 may be able to show individual student results as well as consolidated data across the class, grade, and/or team.

The points engine 58 may be configured to determine scores for student interactions with the software tool 60. For instance, if a user spells a word correctly on a list of vocabulary words, then that user may earn points for that interaction. The points engine 58 may awarded points to the student based on different outcomes or events. As some possibilities, the points engine 58 may implement one or more of the following (i) an overall accuracy rate may be determined for the document itself, enabling a reward of points relative to the document as a whole, (ii) words that are spelled correctly, but which the student has a history of spelling incorrectly, may be awarded points; (iii) words that are spelled incorrectly, but which the student is able to successfully correct, may be awarded points, (iv) if a word is spelled correctly, points may be awarded as a bonus to augment an overall tally, and/or (v) if a word is spelled incorrectly, points may be deducted from the overall tally. A scoreboard may be provided to the user to show an historical score along with a current-document score.

Different amounts of points may be assigned to different words. These point scores may be based on the relative difficult of spelling the words. A word that is harder to spell may be worth more points than an easier to spell word. Point scores for each word may be predefined. Or the point scores for each word may be algorithmically determined by the cloud server 52 (e.g., according to factors such as word length, vowel construct, grade level assigned to the word, etc.). The points engine 58 may utilize the point scores to adjust the points of the user. For instance, if a student spells a word correctly, then the student may be allocated that number of points. If the student spelled the word incorrectly, then that amount of points may instead be deduced from the student.

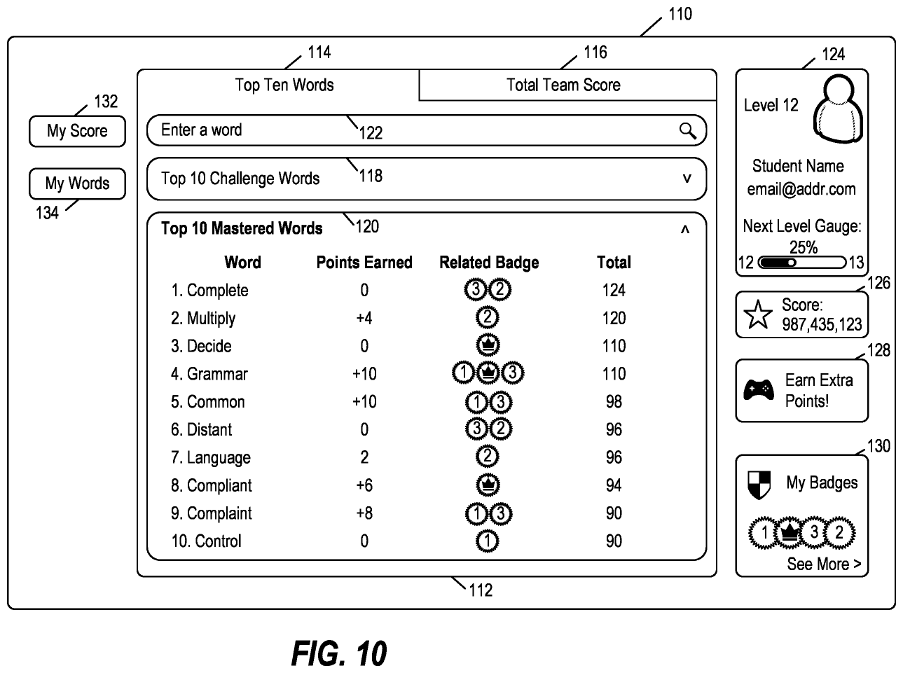

The reporting tool 64 may be configured to generate and present various types of statistics with respect to student usage of the system 50. For instance, a student's overall performance through a period of time may be tallied through the points awarded by the points engine 58, allowing tallies to be tracked individually or collectively. For example, a student's point tally may be compared with the point tallies of others—e.g., other members of the same class. Alternatively, the points may be tallied at a class level—e.g., allowing all classmates to work toward a collaborative goal, or in larger groups to promote fun and competition. (Aspects of an embodiment of the presentation of such reporting are discussed in detail with respect to FIGS. 10-15.) Rewards may be provided individually or at the group level—e.g., a student may be allowed to pick a prize from a box, or a class as a group may have a party if the total score exceeds a certain threshold.

As some concrete examples, the system 50 may use the student records 56 to identify which words are spelled correctly or incorrectly the most for the student. In an example, the system 50 may provide a report for a student showing the words that the user is having the most trouble spelling. As used herein, the term “challenge word” refers to any word misspelled by the user while using of the system. Such challenge words may be presented as a proofreading game, stored in the database for analysis, or used to identify previously misspelled words in future documents. In another example, the system 50 may provide a report for a student showing the words that the user has made the most improvement on. For instance, a word may have been misspelled by a student many times, but later is spelled correctly by the same student. This may indicate that the student has mastered the spelling of that word. These reports and statistics may additionally be run for a group of students on a team, and/or for a school class of students. By way of example, a teacher may use the tool to identify commonly misspelled words across their class or within groups of students. From that information, the tool may be used to create custom assignments or word games for the selected group of students; creating a custom learning assignment tailored to the selected students.

The system and subsequent point tally may be used to provide external rewards offered by teachers, parents, or by third-party partners 67, e.g., discounts at ice cream store, free items from online video games, etc. In some examples, a marketplace may be utilized to present reward options to users and to provide incentives for higher-level scores. In some embodiments, points may be saved to increase the total to allow students to get more desirable rewards. Parents or teachers may set up custom rewards, keep track of points via a mobile-software application that is compatible with the system, receive reports on correct and incorrect words, identify a reading level of the student, provide suggestions for teaching or coursework, generate custom word games or assignments based on tracked words or new words (i.e. currently assigned to the class or that teachers or parents want to emphasize for the student or group), or suggest products from third parties to support student. As one specific example, if a student is identified as spelling animal names incorrectly, then the system 50 may recommend that the student purchase a book on animals from a third-party partner 67 to practice those verbal skills. Additionally, custom games can be generated by the system which reflect challenge words for students or for a whole class. These custom games may be provided to a class as work assignments. The teacher may also add in more words (that are ones the teacher may want the class to learn) to the system to add them to a word search (as an example).

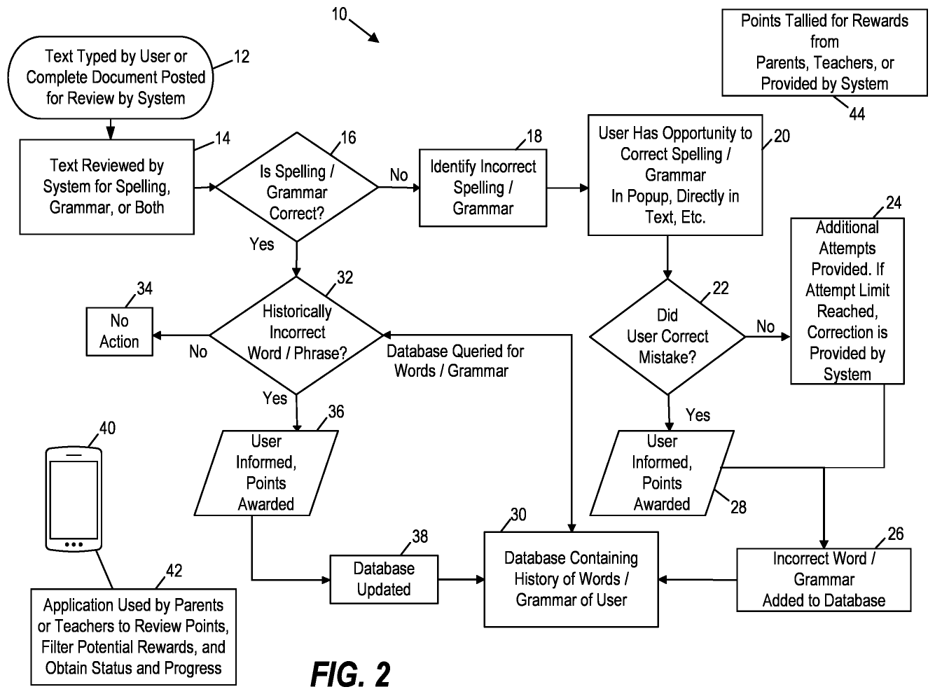

FIG. 2 shows a flowchart 10 schematically illustrating a system and method in accordance with embodiments described herein. As described above, the method may be implemented using the software tool 60 run on a hardware device such as a computer that includes one or more processors and one or more different types of memory, such as RAM, ROM, or both. A method implemented by the system starts at step 12 when a user of the student device 62 types text, for example, in a word-processing program or a browser, just to name two examples. Alternatively, an entire document may be provided as an input at step 12 and the entire document analyzed. At step 14, the text is reviewed by the system for spelling, grammar, or both. Different embodiments may focus on spelling, others may focus on grammar, and some may analyze both spelling and grammar. Points may be awarded at step 16 based on overall accuracy of the document.

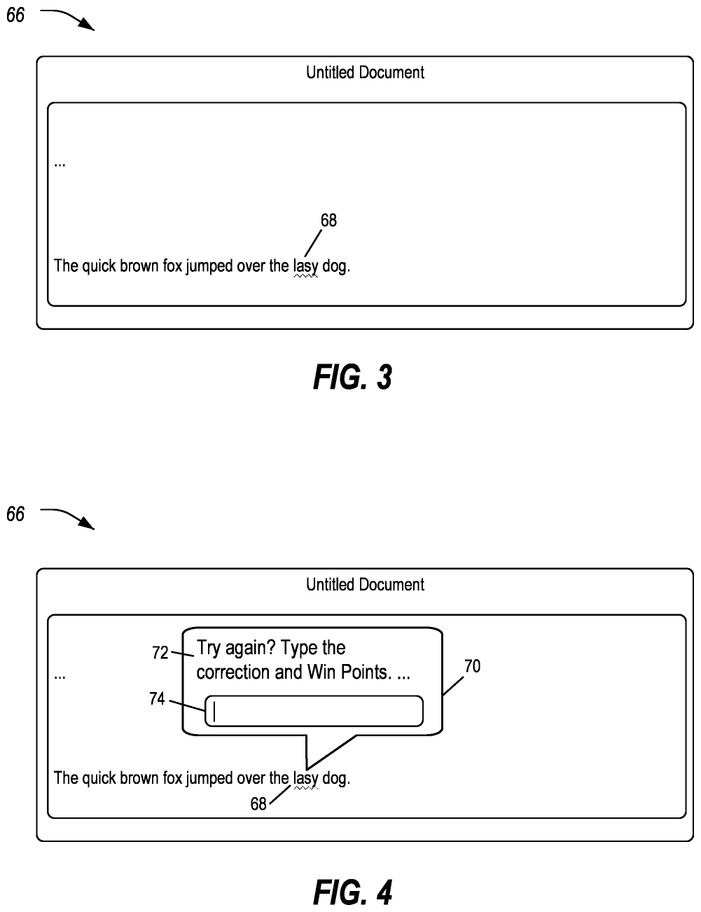

At decision block 16, the system determines if the spelling or grammar, as applicable, is correct. If it is not, the system identifies those portions that are incorrect at step 18. This identification may be performed, for example, by comparing the spelling of the words of the text to a dictionary of words and identifying words that are in the text but not in the dictionary. Correct spellings of the misspelled words may be determined using various techniques, such as a predefined mapping of typical misspellings to usual corrections, or computing edit distance between a misspelled word and the words in the dictionary and suggesting the words with the shortest edit distance. In some examples, spelling corrections may be provided to the software tool 60 using a spelling correction web service. As identified, the identification may be visualized to the user in the form of underlining, highlighting, or other ways of notifying the user that the particular text is incorrect alternatively, the error may be hidden from the user and presented in step 20. At step 20, the user may then be prompted through a pop-up window, or directly in the text itself, to attempt to provide a correction or to complete a game based on the spelling/grammar error. (Further examples of an embodiment of the popup window are shown in detail with respect to FIGS. 3-6, discussed in detail below.) At decision block 22, the system determines whether the user made the appropriate corrections. If they did not, additional attempts may be provided at step 24. The number of additional attempts may be adjustable, and in some embodiments, no additional attempts may be provided. As shown at step 24, an attempt limit may be set so that once this limit is reached, the appropriate correction is provided by the system. Once this happens, the incorrect word or grammar is added to a database at step 26.

Returning to decision block 22, if the user corrects the mistake that was identified at step 20, the system moves to step 28 where the user is informed of their success, and again the incorrect word or grammar is added to the database at step 26. The database 30 may be configured as electronic storage or cloud based storage as noted above, residing on a chip or disc as part of the hardware portion of the system 50. This is the process that may be implemented if the spelling or grammar is incorrect as determined at decision block 16. If, however, the spelling or grammar is correct, the method takes another path from decision block 16.

From decision block 16, the method moves to decision block 32 if the spelling or grammar being analyzed is correct. More specifically, the system determines at decision block 32 whether the incorrect word or phrase has been previously identified as incorrect during another analysis. As described above, this may be the history of a particular user, or the history at a group level, such as a class of students. In the case of a group, the history may reflect the group's previous work with the particular word or phrase. In order to make this determination at decision block 32, the database 30 is queried. As shown in the flowchart 10, information is passed to and from decision block 32 and database 30.

If, after querying the database 30, it is determined that the particular word or phrase is not one that has been historically incorrect, the system has completed the analysis, e.g., at step 34. If, however, the word or phrase is identified as one that is historically incorrect, the user is informed and points are awarded at step 36. Points are awarded (e.g., using the points engine 58) because the historically incorrect word or phrase has been spelled or used correctly as previously determined at decision block 16. After the user is informed that the word or phrase has been spelled or used correctly and the points are awarded at step 36, the system moves to step 38 to update the database 30. The flowchart 10 includes two associated steps that may be integrated into the system or executed separately. At step 40, the software tool 60 or another software application, for example, installed on a reviewer device 42, may be used by parents or teachers to review points, decide on potential rewards, and obtain status and progress of a user or group of users. At step 44, the total points may be tallied—again by parents or teachers or by the software tool 60—to determine an appropriate reward, which may be provided by a person, or integrated into and provided directly by the system.

FIG. 3 illustrates an example of a document 66 including a spelling error 68. The document 66 may be a portion of text that is being written by a student by using a learner or student device 62 to which the software tool 60 is installed. A user interface displaying the documents 66 is illustrated. As shown, a spelling error 68 is identified for the word “lazy”, which is misspelled using an “s” instead of a “z”. The software tool 60 provides an indication of the misspelling in the user interface, in this example as a jagged underline. The underline may signify to the user that the word is not correctly spelled.

FIG. 4 illustrates an example of the document 66 of FIG. 3 displaying a correction interface 70. The correction interface 70 may be displayed responsive to the user having selected the spelling error 68 from the user interface shown in FIG. 3. This selection may include, for instance, clicking on the spelling error 68, tapping or pressing on the spelling error 68, etc. The correction interface 70 may include a popup window, in an example.

The correction interface 70 may include content to allow the user to attempt to correct the spelling error 68 in a gamified manner. Significantly, and in contrast to typical spell checker or grammar checker functions, the correction interface 70 may not begin by providing the correct spelling. In the example shown in FIG. 4, the correction interface 70 includes a message 72 asking the user to try again to spell the word to earn points (e.g., to be given by the points engines 58). The correction interface 70 may further include an input box 74 or other control into which the user may type in the corrected spelling.

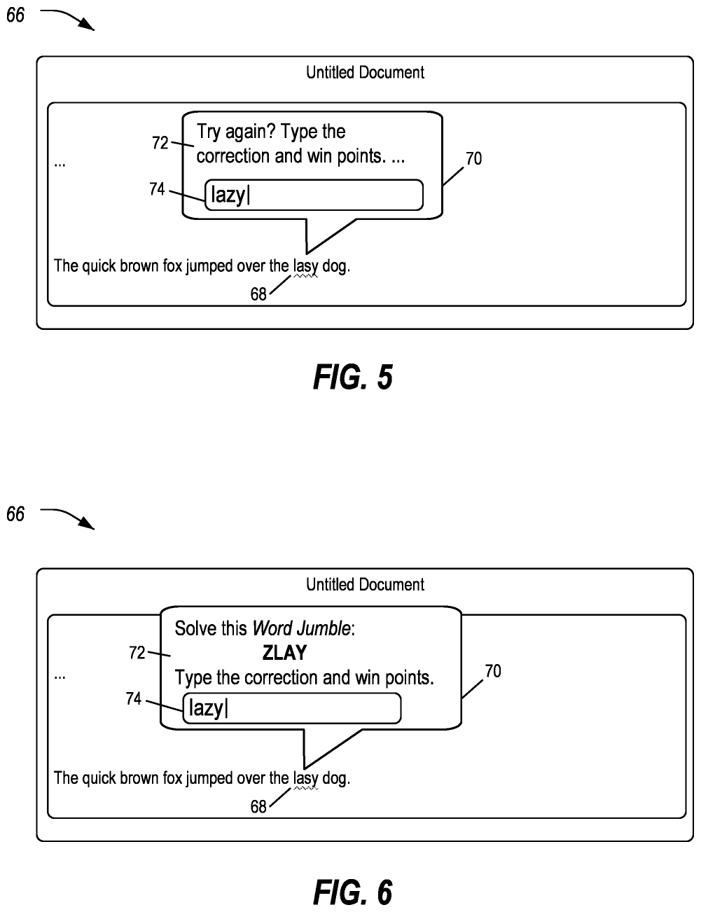

FIG. 5 illustrates an example of the document 66 of FIGS. 3-4 into which the user has entered a replacement for the spelling error 68. As shown, the user has entered the correct spelling of the word “lazy.” If the user enters a correct spelling for the word indicated by the spelling error 68, then the correction interface 70 correction interface 70 may close, and the corrected spelling may replace the spelling error 68 in the document 66. The user also may make corrections directly in the original text. The user may also earn points or a reward for making the correction. For instance, different words may be worth different amounts, and the system 50 may utilize the points engine 58 to award the student the amount of points or the reward corresponding to the word if the student correctly spells the word in the correction interface 70.

FIG. 6 illustrates an alternate example of the correction interface 70 providing a word jumble puzzle. In the alternate example, instead of simply asking the user to try again, the correction interface 70 provides an anagram or word jumble puzzle to be solved by the user. The word jumble puzzle includes a message 72 showing the letters of the corrected word out of order, and prompts the user to enter the correct spelling into the input box 74. If the user enters a correct spelling for the word indicated by the spelling error 68, then the correction interface 70 may close, the corrected spelling may replace the spelling error 68 in the document 66. As noted above, the student may earn points for making the correction.

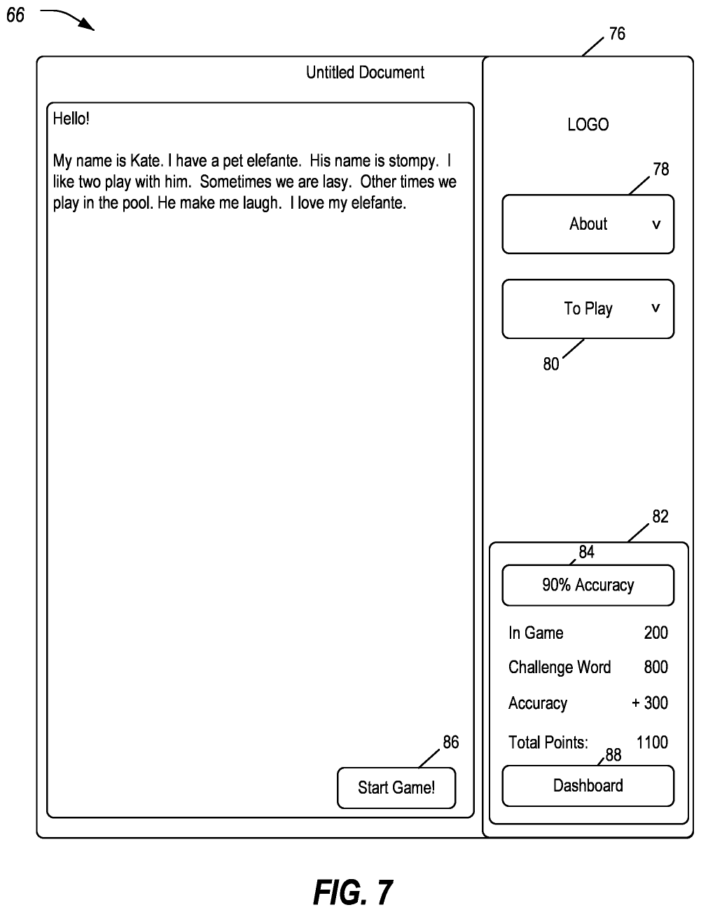

FIG. 7 illustrates an example of a sidebar 76 integration of the software tool 60 into the user interface for editing the document 66. The sidebar 76 may be integrated into a software application for writing document 66, such as a word processor, or web-based online office suite. The sidebar 76 may be displayed alongside the document 66 currently being edited. Using the sidebar 76, the student may perform various operations. For instance, the sidebar 76 may include an about control 78 that, when selected, provides the user with information about the software tool 60 such as version, author, etc. The sidebar 76 may also include a “to play” control 80 that, when selected, provides the user with rules or other information about how to use the software tool 60.

The sidebar 76 may also include scoring information 82 for the document 66. This scoring information 82 may include, for example, accuracy statistics for the document 66. These statistics may indicate, for example, the percentage of words that are correctly spelled in the document 66, the percentage of sentences in the document 66 that are free of grammatical errors. The scoring information 82 may include other information as well, such as the points accumulated by the user, overall accuracy of the user, etc.

In the given example, the document 66 includes five errors: (i) in the second sentence, the word “elephant” is misspelled; (ii) in the fourth sentence the word “two” is used in place of the homophone “to”; (iii) the word “lazy” is misspelled in the fifth sentence; (iv) there is incorrect subject verb agreement in the seventh sentence; and (v) the word “elephant” is misspelled again in the last sentence.

Out of the words of the document 66, approximately 90% of the words are free of proofreading errors. The sidebar 76 indicates this level of accuracy to the student at 84. Information on which words the student spells correctly and which words the student spells incorrectly may also be sent by the software tool 60 to the cloud server 52. The cloud server 52 may maintain this information in the student records 56 to keep track of these proofreading mistakes.

It should also be noted that, as opposed to the examples in FIGS. 3-6, in FIG. 7 the underlines that typically indicate misspellings or grammatical errors are not shown to the student. This allows for the student to compose the document 66 based on the student's verbal knowledge, without relying on the spell checker or grammar checker to indicate mistakes as the student writes. This allows for the accuracy score to better reflect the student's knowledge, as the student will not see indications of errors and attempt to correct the document 66 before finishing.

The user interface may also include a start game control 86. When selected by the student, the start game control 86 allows the user to play one or more games to improve the user's verbal skill. These games may be based on the proofreading errors that are located in the document 66. In an example the proofreading errors may be identified responsive to the user selecting to begin the game. The user interface may also include a dashboard button 88 that, when selected, shows a dashboard interface 110 (discussed in detail below).

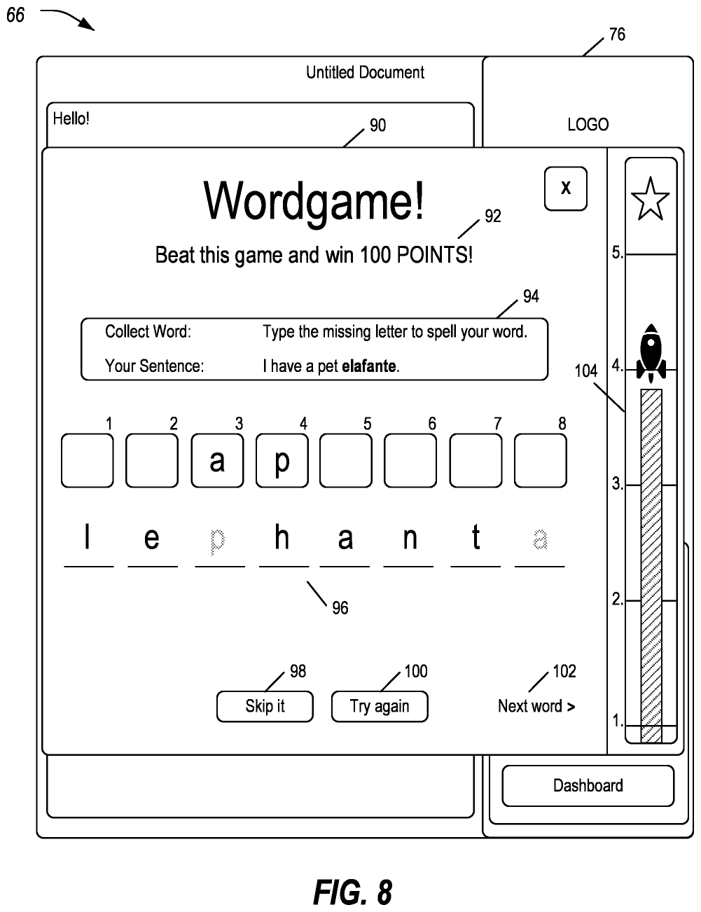

FIG. 8 illustrates an example of a game interface 90 provided by the software tool 60 integrated into the user interface for editing the document 66. In general, the game interface 90 may allow the user to play various types of game to win points for correctly performing verbal skills. In the example of FIG. 8, the game interface 90 provides a word jumble game in which a user unscrambles the letters of a word into its correct spelling.

The game interface 90 may include a points indication 92 of the amount of points that may be gained by completing the puzzle. In this example, completion of the puzzle may allow the user to gain 100 points.

Significantly, the games that are provided in the game interface 90 may be based on the proofreading errors that are located in the document 66. For instance, there are five mistakes located in the document 66 in FIG. 7. Thus, in the illustrated example the software tool 60 may generate a series of five games for display in the game interface 90. Each of the games may include a puzzle that, when solved, illustrates a correction for a respective one of the proofreading mistakes. By completing these games, the student may practice the particular verbal skills that are indicated by the located proofreading errors as needing improvement. The results of the games may also be provided by the software tool 60 to the cloud server 52 to update the student records 56.

The game interface 90 may include a puzzle description 94 explaining the game to be performed. In this example, a puzzle description 94 indicates that the word “elephant” is to be correctly spelled in a game board 96. The puzzle description 94 may show this word in the context that it is used in the document 66. For example, the game interface 90 in this example includes the sentence from the document 66 in which the proofreading error occurred as context. In this case this is the sentence in which the word is incorrectly spelled.

In the example game, the game board 96 may include a set of the letters of the word to spell (shown in the lower row). These letters may be dragged and dropped into in the upper row. Letters that are used in the lower row may appear in a different manner (e.g., faded, a different color, etc.) to inform the student that the letter is already being used in the game board 96. The game interface 90 may also indicate to the user when the word is correctly spelled.

The game interface 90 may further include a skip control 98 that, when selected, allows a user to move to a different word puzzle. The game interface 90 may also include a try again control 100 that, when selected, allows a user to repeat the same word puzzle. When the user has completed (or lost) the puzzle, the user may select a next word control 102 to move to the next puzzle. In some examples, the game interface 90 may automatically advance to the next game responsive to a correct result being entered.

The game interface 90 may also include a score indicator 104 to help show the number of correctly answered puzzles. As shown, the score indicator 104 indicates a score of 4 correct answers. This may indicate that, out of the five errors located in the document 66, four of them have been played to a correct result in the game interface 90. The score indicator 104 may indicate the status of the game to the student, as well as visually incentivize the student to complete the games.

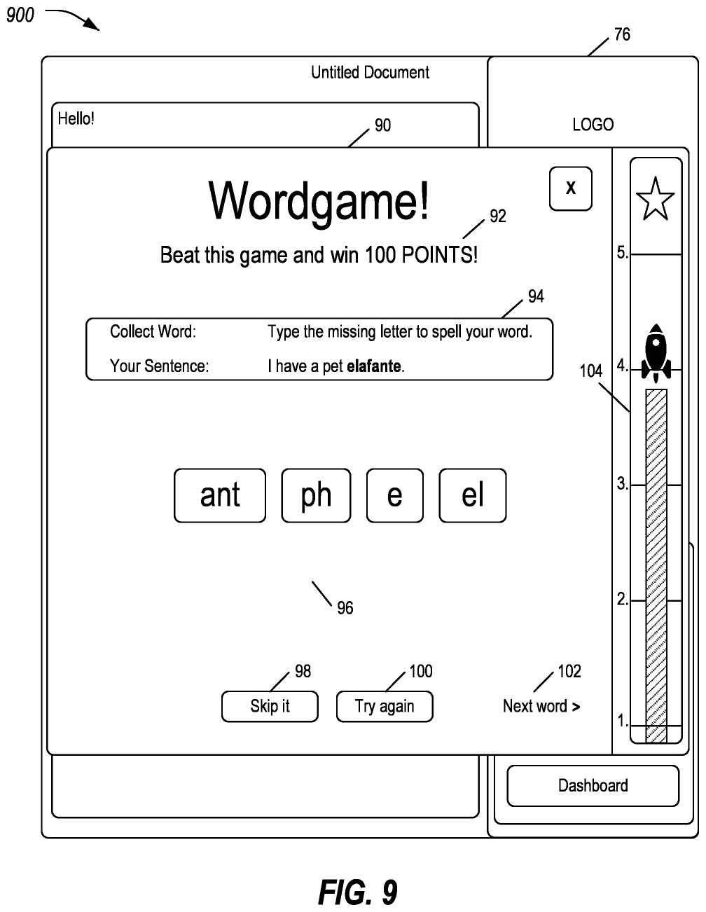

FIG. 9 illustrates an alternate example of a game interface 90 provided by the software tool 60 integrated into the user interface for editing the document 66. As compared to the example shown in FIG. 8, in FIG. 9 the game interface 90 includes portions of the word to be unscrambled instead of individual letters. For instance, similar to the game shown in FIG. 8, the student may rearrange a randomized order of word chart portions of the word (or other groupings of letters of the word, such as syllables) into the correct order.

FIG. 10 illustrates an example dashboard interface 110 for a student using the system 50. In an example the dashboard interface 110 may be provided to the student device 62 by the reporting tool 64 of the cloud server 52. For instance, the student may select the dashboard button 88 shown in FIG. 7 to display the dashboard interface 110. As another example, the student may log into a website (or other account interface) of the reporting tool 64 to view the dashboard interface 110.

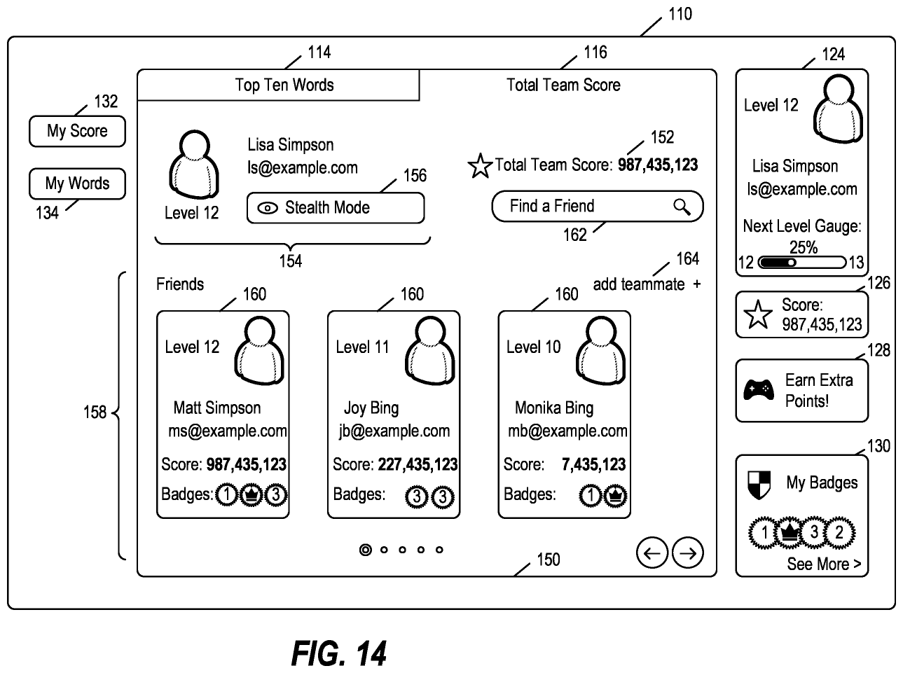

The dashboard interface 110 may include a main display area 112 that provides detailed information about the student's status and progress. The main display area 112 may include a top ten words tab 114 and a total team score tab 116. In FIG. 10, the top ten words tab 114 is selected. The total team score tab 116 is selected in FIG. 14, discussed below.

The top ten words tab 114 may include information about the words that the specific student needs work on (shown as a listing of challenge words 118) as well as a listing of words that the student has learned (shown as a listing of mastered words 120). The challenge words 118 may be those words that are a challenge for the student; these may be the words that the student spells wrong the most.

In the example of FIG. 10, the mastered words 120 list is expanded. The mastered words 120 may show those words for which the student has the highest scores out of words that the student spells in documents 66. Although not expanded, the challenge words 118 may show those words for which the student has the lowest scores out of the words that the student has been spelling in documents 66. Each list may also show additional information for each word, including a total score earned for that word (e.g., by correctly spelling the word), points earned recently for that word (e.g., in the last document 66, in the last week or other time period, etc.), and badges related to the word.

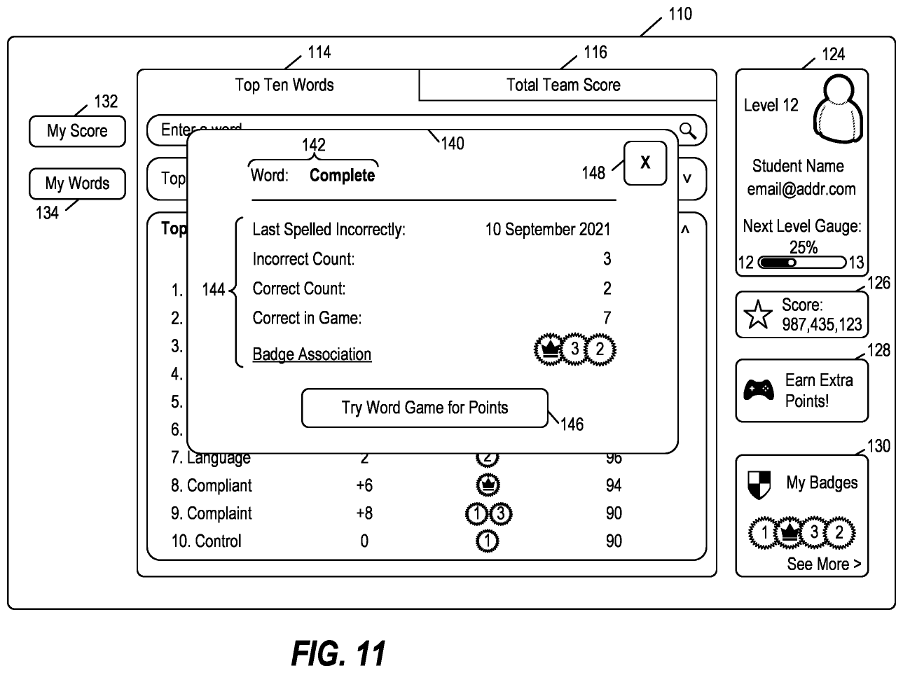

The mastered words 120 and the challenge words 118 lists may allow for selection of the words to show details of the student's progress with the word. An example of details for one of the words is discussed below with respect to FIG. 11. The dashboard interface 110 may also include a find control 122 that, when selected, allows the user to search the expanded word list (e.g., the full database containing mastered words 120 or the challenge words 118) for a word or words including the specified string.

With respect to badges, words may be assigned to badges by a teacher or other administrative user. In one example, a set of words for a first grade student to learn may be assigned to a first grade badge (illustrates in the example as a badge with a “1”). Similarly, badges may be assigned to words for second grade with a “2” badge, third grade with a “3” badge, etc. Other types of badges may be used, instead of or in addition to badges by grade. For instance, a leader badge may be assigned to a set of words by a teacher to encourage mastery of those words by the students.

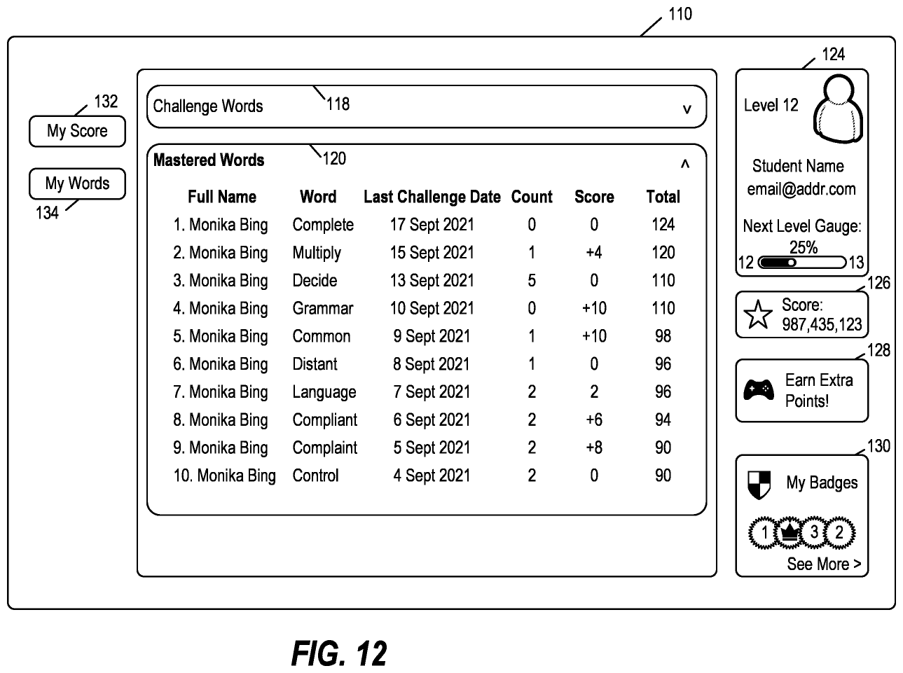

The dashboard interface 110 may also show other student information gleaned from the student records 56. For instance, the student records 56 may be used to provide a student summary 124. The student summary 124 may illustrate information such as the student's name, an email address for the student, and/or an image of the student. The student summary 124 may also indicate the progress level of the student in learning verbal skills. As shown, the student is of level 12. The level may be an indication of various aspects of the student's progress. In an example, if the student has learned to spell all the words for level 12, then the student may move to level 13. The student summary 124 may also indicate how far along the user is to achieving the next level. In FIG. 12, the student summary 124 shows the student is 25% of the way to the next level.

The dashboard interface 110 may include additional elements as well. For instance, the dashboard interface 110 may include a points total 126 for the student. In another example, the dashboard interface 110 may include an earn extra points 128 control that, when selected, allows the student to play more games. This may be similar to the start game control 86, but may include games that are based on the challenge words 118 that the student is currently having trouble spelling (as opposed to being based on a document 66 that is being edited). The dashboard interface 110 may also include a badges control 130 that illustrates the badges that the student has earned.

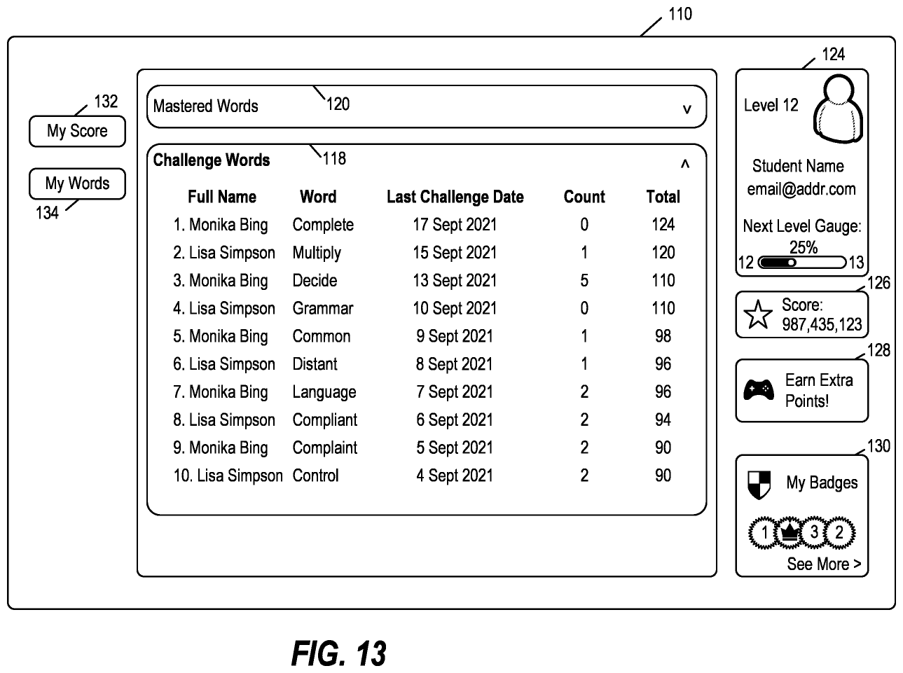

The dashboard interface 110 may also include a my score control 132 that, when selected by the student, allows the student to see further details of the student's score. This may include, for example, a listing of the words that have been spelled correctly and the points earned for each of those words. The dashboard interface 110 may also include a my words control 134 that, when selected by the student, allows the student to see further details of the student's words. An example such a words listing is illustrated in FIGS. 12-13 below.

FIG. 11 illustrates an example dashboard interface 110 for a student user of the system 50 showing a details view 140 for a word. As shown, the details view 140 may be shown responsive to the user selecting one of the words from the dashboard interface 110. In this case, the word is “Complete” has been selected from the mastered words 120 list.

The details view 140 may include an indication of the selected word 142. The details view 140 may also include word statistics 144 for the student's progress with the selected word 142. For instance, the word statistics 144 may indicate the last time the selected word 142 was spelled correctly, a total number of times the selected word 142 was spelled incorrectly, a total number of times the selected word 142 was spelled correctly, a total number of times the word was correctly entered in the game interface 90, and any badges associated with the selected word 142. The details view 140 may also include a word game control 146 that, similar to the start game control 86 and the earn extra points 128, may allow the student to play additional word games for points. These word games may include the selected word 142, in an example. The details view 140 may also include a close control 148 that may be selected to close the details view 140 and return to the dashboard interface 110.

FIG. 12 illustrates an example dashboard interface 110 for a student user of the system 50 showing the mastered words 120 for the student. The interface of FIG. 12 may be displayed responsive to the user selecting the my score control 132. Similar to the mastered word 120 list shown in FIG. 10, the mastered words 120 in FIG. 12 shows additional details with respect to the words that the student has gained mastery over. These details may include, for example the name of the student having mastered the word, the word itself, the last challenge date at which the student was asked to spell the word, the count of times that the student has spelled the word, the points earned for spelling the word (e.g., during the last challenge), and the total points earned by the student for spelling the word.

FIG. 13 illustrates an example dashboard interface 110 for a student user of the system 50 showing the challenge words 118 for the student. For example, the student may have selected from the interface of FIG. 12 to expand the challenge words 118. Similar to the FIG. 12, the interface now shows additional details with respect to the words the student has not yet gained mastery over.

FIG. 14 illustrates an example dashboard interface 110 for a student user of the system 50 showing a team score view 150. The team score view 150 may be displayed, for example, responsive to the student selecting the total team score tab 116 from the dashboard interface 110. The team score view 150 may indicate a total team score 152 for the team that the student is on.

The team score view 150 may also include a team member summary 154 including information about the student. Similar to the student summary 124, this information may include the student's name, email address, image, level, etc. The team member summary 154 may also include a stealth mode control 156 to allow the student to toggle between sharing student's score information with other members of the team.

The team score view 150 may also include a friends list 158. The friends list 158 may include student information for each of the other students that are on the student's team. As shown, each of the friends of the student is shown as a friend information summary 160, similar to the student's own student summary 124. For instance, the friend information summaries 160 may include information such as the friend's name, email address, level, score, and earned badges. The friends list 158 may also include a find friends control 162 that allows the student to search the friends list 158 for a name, email, etc. The friends list 158 may also include an add teammate control 164 that when selected brings up an interface for the student to add and invite friends to the student's team.

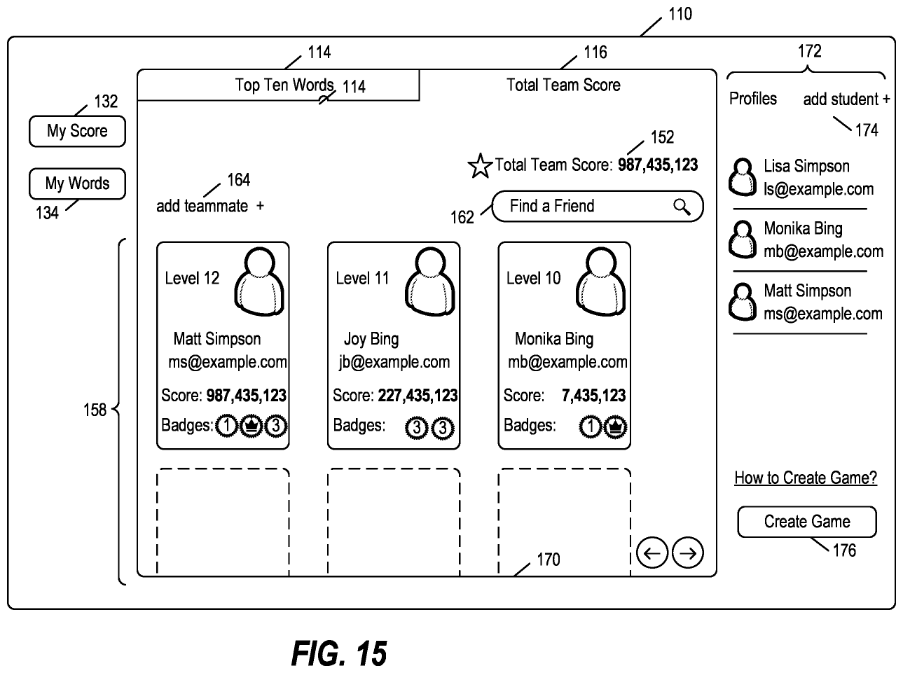

FIG. 15 illustrates an example dashboard interface 110 for a teacher user of the system 50 showing a classroom view 170. Similar to the student view, the teacher view may display various information about the student's activities. For instance, the classroom view 170 may be switched between the top ten words tab 114 and the total team score tab 116. As another example, in the total team score tab 116, the classroom view 170 may include a total team score 152, a friends list 158, a find friends control 162, and an add teammate control 164.

The classroom view 170 may also include teacher-specific functionality. For instance, the classroom view 170 may include a student profiles list 172. The student profiles list 172 may display, for example, a listing of the students that the teacher has in a class. The student profiles list 172 may include an add student function 174 that, when selected by the teacher, allows the teacher to browse for kids to add to the teacher's class.

The classroom views 170 may also include a create game control 176. The teacher may select the create game control 176 to create a game. For example, the teacher may select from the list of challenge words 118 to create a custom set of games to give to the class, where the custom game includes a game for each of the challenge words 118.

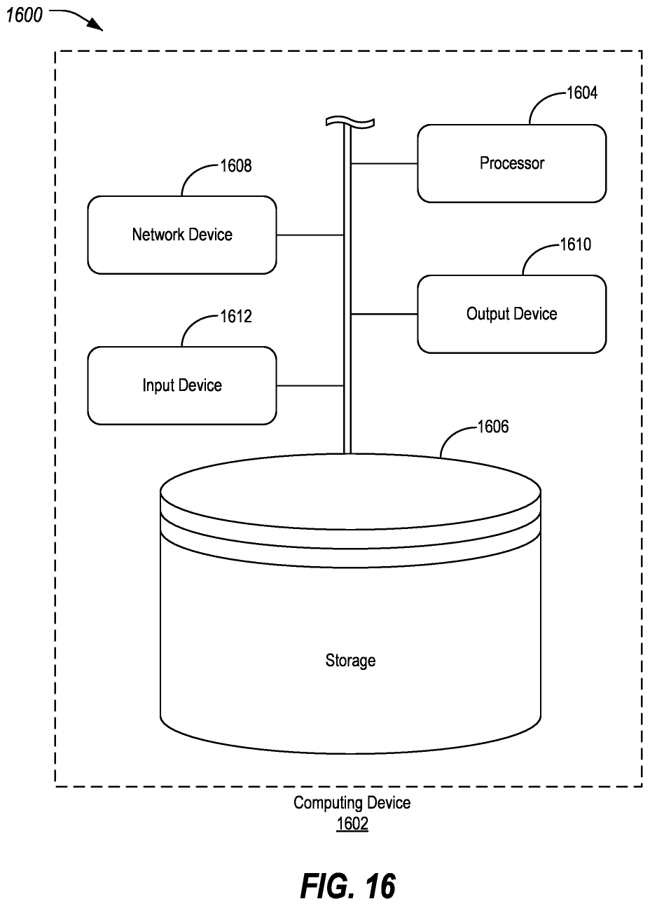

FIG. 16 illustrates an example computing device 182 for use in improving verbal skills. Referring to FIG. 16, and with reference to FIGS. 1-15, the cloud server 52, reviewer devices 42, and student devices 62 may include examples of such computing devices 182. Computing devices 182 generally include computer-executable instructions, such as those of the software tool 60, points engine 58, reporting tool 64, where the instructions may be executable by one or more computing devices 182. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the student records 56, may be stored and transmitted using a variety of computer-readable media.

As shown, the computing device 182 may include a processor 184 that is operatively connected to a storage 186, a network device 188, an output device 190, and an input device 192. It should be noted that this is merely an example, and computing devices 182 with more, fewer, or different components may be used.

The processor 184 may include one or more integrated circuits that implement the functionality of a central processing unit (CPU) and/or graphics processing unit (GPU). In some examples, the processors 184 are a system on a chip (SoC) that integrates the functionality of the CPU and GPU. The SoC may optionally include other components such as, for example, the storage 186 and the network device 188 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 184 executes stored program instructions that are retrieved from the storage 186. The stored program instructions, accordingly, include software that controls the operation of the processors 184 to perform the operations described herein. The storage 186 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic RAM that stores program instructions and data during operation of the system 50.

The GPU may include hardware and software for display of at least two-dimensional (2D) and optionally three-dimensional (3D) graphics to the output device 190. The output device 190 may include a graphical or visual display device, such as an electronic display screen, projector, printer, or any other suitable device that reproduces a graphical display. As another example, the output device 190 may include an audio device, such as a loudspeaker or headphone. As yet a further example, the output device 190 may include a tactile device, such as a mechanically raiseable device that may, in an example, be configured to display braille or another physical output that may be touched to provide information to a user.

The input device 192 may include any of various devices that enable the computing device 182 to receive control input from users. Examples of suitable input devices 192 that receive human interface inputs may include keyboards, mice, trackballs, touchscreens, microphones, graphics tablets, and the like.

The network devices 188 may each include any of various devices that enable the described components to send and/or receive data from external devices over networks. Examples of suitable network devices 188 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A system for improving verbal skills, comprising:
a database; and
one or more computing devices programmed to
analyze text of a user for proofreading correctness,
compare results of the analysis to proofreading related data for the user stored in the database,
update the database to reflect the results of the analysis.

2. The system of claim 1, wherein the one or more computing devices are programmed to:
generate a proofreading game based on the proofreading correctness; and
present the proofreading game to the user.

3. The system of claim 2, wherein the game is a word jumble game configured to receive selection from the user to rearrange letters of a misspelled word into a correct spelling of the misspelled word.

4. The system of claim 2, wherein the game is a segment jumble game configured to receive a selection from the user to rearrange segments of letters of a misspelled words into a correct spelling of the misspelled words.

5. The system of claim 2, wherein the game includes receiving one or more guesses of a correct spelling of a misspelled word.

6. The system of claim 2, wherein, responsive to the user correctly completing one of the proofreading games, the one or more computing devices are configured to provide a reward to the user.

7. The system of claim 1, wherein the one or more computing devices are further programmed to:
identify, from the database, one or more challenge words that the user has spelled correctly in the text but that the user has spelled incorrectly in the past, and
provide a reward to the user.

8. The system of claim 1, wherein the one or more computing devices are further programmed to:
identify, from the database, one or more challenge words that the user has spelled incorrectly, and
generate a proofreading game for the user.

9. A system for improving verbal skills, comprising:
one or more computing devices programmed to
identify a proofreading error;
display a correction interface, the correction interface guiding a user to complete a proofreading game, wherein a winning result of the game involves the user providing a correction of the proofreading error; and
responsive to the user correctly completing the proofreading game, replace the proofreading error with the correction.

10. The system of claim 9, further comprising a database configured to store proofreading related data, wherein the one or more computing devices are programmed to update the database relative to proofreading correctness.

11. The system of claim 9, wherein the one or more computing devices are programmed to generate a plurality of games, each game corresponding to the user's proofreading correctness over a plurality of documents edited by the user.

12. The system of claim 9, wherein the proofreading error is hidden from the user prior to display of the correction interface.

13. The system of claim 9, wherein the proofreading error is an incorrect spelling of a word.

14. The system of claim 13, wherein the proofreading game is a word jumble game provided in the correction interface configured to receive selection from the user to rearrange letters of the word into a correct spelling of the word.

15. The system of claim 13, wherein the proofreading game is a segment jumble game provided in the correction interface configured to receive a selection from the user to rearrange segments of letters of the word into a correct spelling of the word.

16. The system of claim 13, wherein the proofreading game includes receiving one or more guesses of a correct spelling of the word.

17. The system of claim 9, wherein, responsive to the user correctly completing the proofreading game, the one or more computing devices are configured to provide a reward to the user.

18. The system of claim 9, wherein the proofreading error is a grammatical error.

19. The system of claim 9, wherein the proofreading error is located in a word processor document, and the one or more computing devices are programmed to include, in the correction interface, context from the word processor document to illustrate the proofreading error in the proofreading game.

20. The system of claim 19, wherein the context includes at least part of a sentence in which the proofreading error occurs.

21. The system of claim 9, wherein the one or more computing devices are programmed to:
indicate, in a user interface, an indication of the proofreading error located in a document where the proofreading error occurs; and
display the correction interface responsive to selection of the indication by the user.

22. The system of claim 9, wherein the one or more computing devices are programmed to:
identify a plurality of proofreading errors in a document;
generate a plurality of games, each game corresponding to one of the plurality of proofreading errors; and
responsive to selection of a start game control, provide a game interface for playing the plurality of games.

23. A method for improving verbal skills, comprising:
identifying, by one or more computing devices, a proofreading error in a document;
displaying, on an output device, a correction interface, the correction interface including a proofreading game to be played by a user, wherein a winning result of the game involves providing a correction of the proofreading error; and
responsive the user to correctly completing the proofreading game, replacing, by the one or more computing devices, the proofreading error with the correction.

24. The method of claim 23, wherein the proofreading error is an incorrect spelling of a word.

25. The method of claim 24, wherein the proofreading game is a word jumble game provided in the correction interface, and further comprising receiving a selection from the user to rearrange letters of the word into a correct spelling of the word.

26. The method of claim 24, wherein the proofreading game in the correction interface is a segment jumble game, and further comprising receiving a selection from the user to rearrange segments of letters of the word into a correct spelling of the word.

27. The method of claim 24, wherein the proofreading game includes receiving one or more guesses of a correct spelling of the word.

28. The method of claim 23, further comprising, responsive to the user correctly completing the proofreading game, providing a reward to the user by the one or more computing devices.

29. The method of claim 23, wherein the proofreading error is a grammatical error.

30. The method of claim 23, wherein the document is a word processor document, and further comprising including, in the correction interface, context from the word processor document to illustrate the proofreading error in the proofreading game.

31. The method of claim 30, wherein the context is a sentence in which the proofreading error occurs.

32. The method of claim 23, further comprising:
indicating, in a user interface displaying the document, an indication of the proofreading error located in the document where the proofreading error occurs; and
displaying the correction interface responsive to selection of the indication by the user.

33. The method of claim 23, further comprising:
identifying a plurality of proofreading errors in the document;
generating a plurality of games, each game corresponding to one of the plurality of proofreading errors; and
responsive to selection of a start game control, providing a game interface for playing the plurality of games.

34. The method of claim 33, further comprising updating a database to indicate proofreading correctness.

35. The method of claim 34, further comprising generating a plurality of games, each game corresponding to the words that are spelled incorrectly by the user over a plurality of documents edited by the user.

36. A non-transitory computer readable medium comprising instructions that, when executed by one or more computing devices, cause the one or more computing devices to perform operations including to:
identify a proofreading error in a document;
display a correction interface, the correction interface including a proofreading game to be played by a user, wherein a winning result of the game involves providing a correction of the proofreading error; and
responsive to the user correctly completing the proofreading game, replace the proofreading error with the correction.
